(19) United States
(12) Patent Application Publication
(10) Pub. No.: US 2018/0147711 A1
(43) Pub. Date: May 31, 2018

(54) HANDHELD POWER TOOL DEVICE

(71) Applicant: Robert Bosch GmbH, Stuttgart (DE)

(72) Inventor: Dietmar Saur, Moessingen (DE)

(21) Appl. No.: 15/801,408

(22) Filed: Nov. 2, 2017

(30) Foreign Application Priority Data
Nov. 29, 2016 (DE) 102016223678.4

(51) Int. Cl. B25F 5/00; B25F 5/02

(52) U.S. Cl. CPC B25F 5/001; B25F 5/02

(57) ABSTRACT

A handheld power tool device having a drive unit, which includes at least one driveshaft, and at least one rotary percussion mechanism, which includes at least one intermediate shaft oriented at least essentially flush with respect to the driveshaft, and at least two bearings for mounting the driveshaft. It is provided that the bearings for mounting the driveshaft are situated on a side of the drive unit facing toward the rotary percussion mechanism.

### CROSS REFERENCE

The present application claims the benefit under 35 U.S.C. § 119 of German Patent Application No. DE 102016223678.4 filed on Nov. 29, 2016, which is expressly incorporated herein by reference.

### BACKGROUND INFORMATION

A handheld power tool device having a drive unit, which has at least one drive shaft, and at least one rotary percussion mechanism, which includes at least one intermediate shaft, which is oriented at least essentially flush with respect to the driveshaft, and at least two bearings for mounting the driveshaft, is conventional.

### SUMMARY

The present invention is directed to a handheld power tool device having a drive unit, which has at least one drive shaft, and at least one rotary percussion mechanism, which includes at least one intermediate shaft, which is oriented at least essentially flush with respect to the driveshaft, and at least two bearings for mounting the driveshaft.

It is provided that the bearings for mounting the driveshaft are arranged on a side of the drive unit facing toward the rotary percussion mechanism.

A “handheld power tool device” is to be understood in this context in particular as at least one part, in particular a subassembly, of a handheld power tool. In particular, the handheld power tool device may also include the entire handheld power tool. The handheld power tool may be designed as any arbitrary, advantageously electrical machine, but advantageously as a rotary impact screwdriver. A “drive unit” is to be understood in particular as a unit which is provided to convert electrical energy in particular into kinetic energy, in particular rotational energy. The drive unit is designed in particular at least essentially as an electric motor, in particular as a caseless electric motor. The driveshaft is at least partially formed in particular by an armature shaft of the caseless electric motor. “At least essentially flush” is to be understood here in particular as an orientation of the driveshaft and the intermediate shaft in relation to one another, the driveshaft and the intermediate shaft, viewed along an axial direction, being situated at least essentially overlapping the driveshaft and/or the intermediate shaft. “Provided” is to be understood in particular as especially programmed, designed, and/or equipped. An object being provided for a specific function is to be understood in particular to mean that the object fulfills and/or executes this specific function in at least one application state and/or operating state. A “rotary percussion mechanism” is to be understood in this context in particular as a percussion mechanism which is provided to convert an at least essentially continuous power output of a drive unit into a percussion angular momentum. The rotary percussion mechanism may be designed in particular as a cam rotary percussion mechanism or as a V-groove rotary percussion mechanism.

An “intermediate shaft” is to be understood in particular as a shaft of a drivetrain, which is situated in particular between a drive unit and an output shaft, in particular of a handheld power tool. In particular, the at least one intermediate shaft is provided for transmitting a force and/or movement, which is in particular generated by the drive unit, directly and/or indirectly to the output shaft. A “bearing” is to be understood in this context in particular as a radial bearing, which is provided for rotatably mounting the driveshaft in relation to the intermediate shaft. In particular, the bearings for mounting the drive axle may be designed as slide bearings and/or antifriction bearings. The bearings for mounting the drive axle are preferably at least partially designed as antifriction bearings, for example, as ball bearings, roller bearings, or needle bearings. In particular, the handheld power tool device is free of bearings for mounting the driveshaft which are situated on a side of the drive unit facing away from the rotary percussion mechanism.

A generic handheld power tool device having advantageous design properties may be provided by such a design.

In particular, an advantageously compact configuration, in particular an advantageously short overall length of the mounting of the driveshaft and/or an advantageously short overall length of the handheld power tool device may be achieved by the arrangement of the bearings for mounting the driveshaft inside the intermediate shaft. Furthermore, an advantageously short tolerance chain with respect to a mounting of the driveshaft may be achieved. Moreover, a mounting of the driveshaft in a housing of the handheld power tool may be omitted, whereby the housing may advantageously be simply designed and/or a short tolerance chain may be achieved for the arrangement of the handheld power tool device.

Furthermore, it is provided that the bearings for mounting the driveshaft are situated inside the rotary percussion mechanism. In this way, an advantageously compact configuration, in particular an advantageously short overall length of the handheld power tool device may be achieved. The bearings for mounting the driveshaft being situated inside the rotary percussion mechanism is to be understood to mean in particular that the bearings are enclosed at least essentially completely in particular in the circumferential direction by at least one element of the rotary percussion mechanism. In particular, the bearings for mounting the drive axle may be formed at least partially in one piece with at least one element of the rotary percussion mechanism and/or may rest against at least one surface of an element of the rotary percussion mechanism at least partially with a circumference, in particular an outer circumference. In particular, the bearings may be pressed at least partially into at least one element of the rotary percussion mechanism and/or may be inserted at least partially into at least one element of the rotary percussion mechanism and/or may be secured with the aid of at least one securing element, in particular with the aid of a snap ring, inside at least one element of the rotary percussion mechanism. “In one piece” is to be understood in particular as at least integrally joined, for example, by a welding process, an adhesive bonding process, an extrusion process, and/or another process which appears reasonable to those skilled in the art, and/or is advantageously understood as molded in one piece, for example, by manufacturing from a casting and/or by manufacturing in a single-component or multicomponent injection molding method and advantageously from a single blank.

Furthermore, it is provided that the rotary percussion mechanism includes at least one planetary gear having a plurality of planetary wheels interlocked with the driveshaft, the toothing of the driveshaft with the planetary wheels being situated between the bearings for mounting the driveshaft. A “planetary gear” is to be understood in particular as a gear which has at least one planet connected to a planet carrier, which is coupled in the radial direction toward the outside to an annulus gear and/or in the radial direction toward the inside to a sun wheel. The sun wheel, the planet, and/or the annulus gear may be formed in particular by round gearwheels or by out-of-center gearwheels which are coordinated. Multiple planetary gears may be connected in succession and/or multiple stages may be interconnected between planetary wheel and annulus gear. An “annulus gear” is to be understood in particular as a gear wheel which has a collar, which is designed in the form of a cylindrical jacket or in the form of an interrupted cylindrical jacket. In particular, the bearings for mounting the driveshaft are situated in the immediate vicinity of the toothing. In particular, “immediate vicinity of the toothing” is to be understood as an area which is situated spaced apart by less than 5 cm, advantageously less than 2.5 cm, and particularly advantageously less than 1.5 cm from at least one part of the toothing. The intermediate shaft is designed in particular at least partially as a planetary wheel carrier of the planetary gear. Advantageously good concentricity of the planetary gear of the rotary percussion mechanism may be achieved in this way.

Furthermore, it is provided that the driveshaft is mounted at least partially inside the intermediate shaft. The intermediate shaft preferably has at least one receptacle recess, which is provided for at least partially accommodating the driveshaft. In particular, the receptacle recess extends along a rotation axis of the intermediate shaft. In particular in an installed state, the driveshaft protrudes at least partially into the intermediate shaft, in particular into the receptacle recess of the intermediate shaft. At least one of the bearings for mounting the driveshaft is preferably situated inside the intermediate shaft. At least one bearing for mounting the driveshaft is preferably at least partially, advantageously completely situated inside the receptacle recess of the intermediate shaft. An advantageously low-friction mounting of the driveshaft may be achieved in this way. Furthermore, by arranging the bearing inside the receptacle recess, an advantageously short overall length of the rotary percussion mechanism may be achieved. An advantageously short overall length of the handheld power tool device may be achieved in this way.

In one embodiment of the present invention, it is provided that at least one bearing for mounting the driveshaft is situated inside at least one element of the rotary percussion mechanism which is different from an intermediate shaft. The rotary percussion mechanism preferably includes at least one percussion mechanism cover and at least one bearing for mounting the driveshaft is situated inside the percussion mechanism cover. A “percussion mechanism cover” is to be understood in this context in particular as a cover element which is provided for at least largely closing the rotary percussion mechanism in a direction of at least one further handheld power tool unit, in particular in the direction of a drive unit. “At least largely” is to be understood in this context in particular as at least 51%, preferably at least 65%, and particularly preferably at least 75%. In particular, the percussion mechanism cover has at least one lead-through recess, which is provided for at least partially leading through at least one shaft, in particular a driveshaft. In particular, the percussion mechanism cover may be formed in one piece with an annulus gear of the planetary gear. At least one bearing for mounting the driveshaft being situated inside an element of the rotary percussion mechanism, in particular inside the percussion mechanism cover, is to be understood in particular to mean that at least one bearing for mounting the driveshaft is at least essentially enclosed by the element of the rotary percussion mechanism in the circumferential direction. The element of the rotary percussion mechanism, in particular the percussion mechanism cover, has at least one bearing receptacle, which is provided for receiving the bearing for mounting the driveshaft. A “bearing receptacle” is to be understood in this context in particular as an area formed at least partially by the percussion mechanism cover, which is provided for a fixed arrangement of the bearing for mounting the driveshaft inside the element of the rotary percussion mechanism. The bearing receptacle is in particular formed in one piece with the element of the rotary percussion mechanism. In particular, an internal diameter of the bearing receptacle at least essentially corresponds to an external diameter of the bearing for mounting the driveshaft. The bearing for mounting the driveshaft is preferably fixed by a press fit in the bearing receptacle. A “press fit” is to be understood in particular as a force-locked connection which may be designed as a transverse and/or longitudinal interference fit. A “force-locked connection” is to be understood in particular as a detachable connection, a retention force between two components preferably being transmitted by a friction force between the components. An advantageously simple, secure, and/or permanent arrangement of at least one bearing for mounting the driveshaft may be achieved in this way.

In one preferred embodiment of the present invention, it is provided that all bearings for mounting the driveshaft are situated inside the intermediate shaft. In particular, the intermediate shaft has at least one bearing receptacle, which is situated at least essentially directly at an insertion opening of the receptacle recess of the intermediate shaft, which is provided for inserting a driveshaft into the intermediate shaft. The bearing receptacle is provided in particular for at least partially accommodating at least one bearing for mounting the driveshaft. In particular, at least one further bearing for mounting the driveshaft is situated at an end of the receptacle recess of the intermediate shaft opposite to the insertion opening. An advantageously simple, secure, and/or permanent arrangement of the bearings for mounting the driveshaft may be achieved in this way.

Moreover, a handheld power tool, in particular a rotary impact screwdriver, having at least one handheld power tool device according to the present invention is provided. An advantageously compact hand-held power tool, in particular an advantageously compact rotary impact screwdriver, may be provided in this way. In particular, the handheld power tool may have an advantageously short overall length.

The handheld power tool device according to the present invention is not to be restricted in this case to the above-described application and specific embodiment. In particular, the handheld power tool device according to the present invention may have a number of individual elements, components, and units, which deviates from a number mentioned herein to fulfill a functionality described herein.

### BRIEF DESCRIPTION OF THE DRAWINGS

Further advantages result from the description below of the figures. Three exemplary embodiments of the present invention are shown in the figures. The figures and the description herein contain numerous features in combination. Those skilled in the art will advantageously also consider the features individually and combine them into reasonable further combinations.

FIG. 1 shows a schematic partial sectional view of a handheld power tool, which is designed as a rotary impact screwdriver.

FIG. 2 shows a detail view of a mounting of a driveshaft of the handheld power tool.

FIG. 3 shows an intermediate shaft of the handheld power tool from FIG. 1 in a perspective view.

FIG. 4 shows a detail view of an alternative mounting of a driveshaft of the handheld power tool.

FIG. 5 shows a schematic partial sectional view of an alternative handheld power tool, which is designed as a rotary impact screwdriver.

FIG. 6 shows a detail view of a mounting of a driveshaft of the alternative handheld power tool.

### DETAILED DESCRIPTION OF EXAMPLE EMBODIMENTS

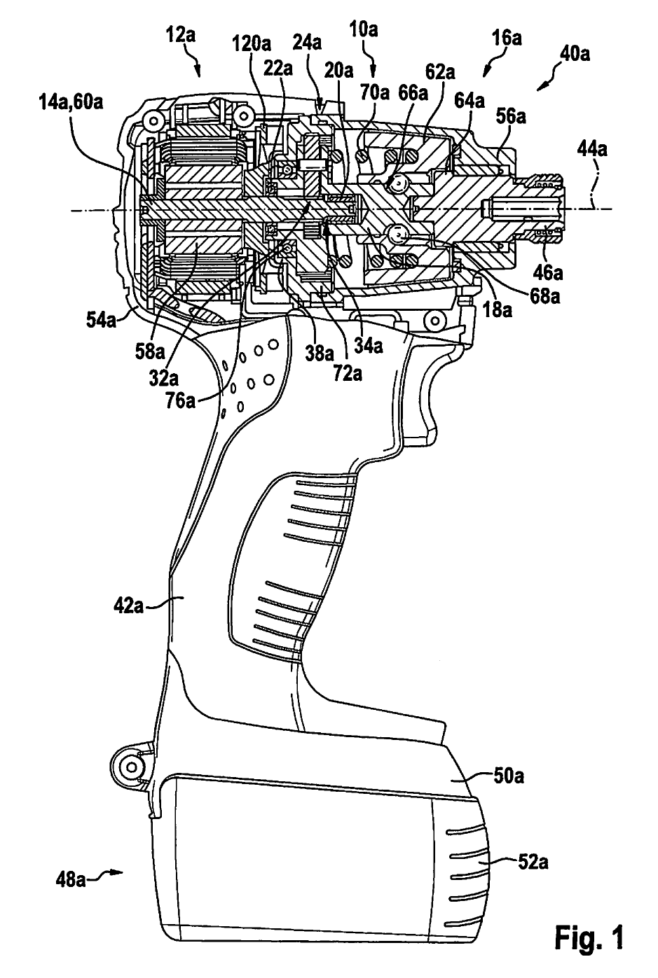

FIG. 1 shows a handheld power tool 40a, which is designed as a rotary impact screwdriver, in a schematic partial sectional view. Hand-held power tool 40a is designed as a cordless rotary impact screwdriver. Hand-held power tool 40a includes a handle 42a which extends at least essentially perpendicularly in relation to a rotation axis 44a of a tool holder 46a, which is provided for holding an insert tool (not shown here), of handheld power tool 40a. Handle 42a includes a rechargeable battery holder 50a on a side 48a facing away from handheld power tool 40a. Rechargeable battery holder 50a is provided for holding a rechargeable battery unit 52a for the power supply of handheld power tool 40a.

Furthermore, handheld power tool 40a includes a handheld power tool device 10a having a drive unit 12a and a rotary percussion mechanism 16a. Handheld power tool device 10a has a drive housing 54a and a percussion mechanism housing 56a. Drive housing 54a encloses drive unit 12a at least essentially completely. Drive housing 54a is designed as a shell housing. Percussion mechanism housing 56a encloses rotary percussion mechanism 16a at least essentially completely. Drive unit 12a is designed as an electrical drive unit, which is supplied with electrical energy with the aid of rechargeable battery unit 52a. Drive unit 12a is designed as an electric motor 58a, which is provided for converting electrical energy provided by rechargeable battery unit 52a into rotational energy. Drive unit 12a has a drive shaft 14a, which is provided for transmitting the rotational energy to rotary percussion mechanism 16a. Driveshaft 14a is formed by an armature shaft 60a of electric motor 58a. Armature shaft 60a is formed in one piece. Rotary percussion mechanism 16a is designed as a V-groove rotary percussion mechanism. Rotary percussion mechanism 16a is provided for converting a continuous power output of drive unit 12a into a percussion angular momentum. The energy output of drive unit 12a is relayed to the insert tool by an impact of a striker 62a of rotary percussion mechanism 16a on a corresponding anvil 64a with the aid of a pulse of high power intensity. Anvil 64a is formed in one piece with tool holder 46a. Striker 62a is mounted in such a way that an axial movement and a radial movement are possible. The control of the axial movement is carried out by V-shaped grooves 66a and driving balls 68a. A spring 70a ensures the restoring movement of striker 62a. Moreover, handheld power tool device 10a has a fan wheel 120a, which is situated between drive unit 12a and rotary percussion mechanism 16a. Alternatively, fan wheel 120a may also be situated on a side of drive unit 12a facing away from rotary percussion mechanism 16a. Fan wheel 120a is provided in particular for producing a cooling air flow for cooling rotary percussion mechanism 16a and/or drive unit 12a. Fan wheel 120a is rotatably fixedly situated on drive shaft 14a of drive unit 12a.

Rotary percussion mechanism 16a has an intermediate shaft 18a, which is oriented at least essentially flush with respect to drive shaft 14a. Furthermore, handheld power tool device 10a has two bearings 20a, 22a for mounting driveshaft 14a. Bearings 20a, 22a for mounting drive shaft 14a are situated on a side of drive unit 12a facing toward rotary percussion mechanism 16a. Bearings 20a, 22a for mounting driveshaft 14a are situated inside rotary percussion mechanism 16a. Driveshaft 14a is mounted at least partially inside intermediate shaft 18a. Intermediate shaft 18a has a receptacle recess 34a, which is provided for at least partially accommodating driveshaft 14a. Receptacle recess 34a extends at least essentially along a rotation axis 44a of intermediate shaft 18a. Driveshaft 14a protrudes in an installed state at least partially into intermediate shaft 18a, in particular into receptacle recess 34a of intermediate shaft 18a.

Bearings 20a, 22a for mounting driveshaft 14a are situated inside intermediate shaft 18a. Bearings 20a, 22a for mounting driveshaft 14a are designed as antifriction bearings.

Rotary percussion mechanism 16a has at least one single-stage planetary gear 24a having a plurality of planetary wheels 26a, 28a, 30a, which are interlocked with drive shaft 14a. A toothing 32a of driveshaft 14a with planetary wheels 26a, 28a, 30a is situated between bearings 20a, 22a for mounting driveshaft 14a. Planetary gear 24a includes at least one annulus gear 72a. Furthermore, rotary percussion mechanism 16a includes a percussion mechanism cover 38a. Percussion mechanism cover 38a is situated between drive unit 12a and planetary gear 24a. In particular, percussion mechanism 38a is provided for at least largely closing rotary percussion mechanism 16a in the direction of drive unit 12a. Percussion mechanism cover 38a is formed in one piece with annulus gear 72a. Percussion mechanism 38a and annulus gear 72a are at least essentially made of a metallic material, in particular a metallic sintered material.

Handheld power tool device 10a furthermore includes an intermediate shaft bearing 76a for mounting intermediate shaft 18a. Intermediate shaft bearing 76a is designed as an antifriction bearing. Alternatively, intermediate shaft bearing 76a may be designed as a slide bearing. Intermediate shaft bearing 76a is designed as a radial bearing, which is provided for rotatably mounting intermediate shaft 18a in percussion mechanism cover 38a. Intermediate shaft bearing 76a is situated at least partially inside a percussion mechanism cover 38a of rotary percussion mechanism 16a.

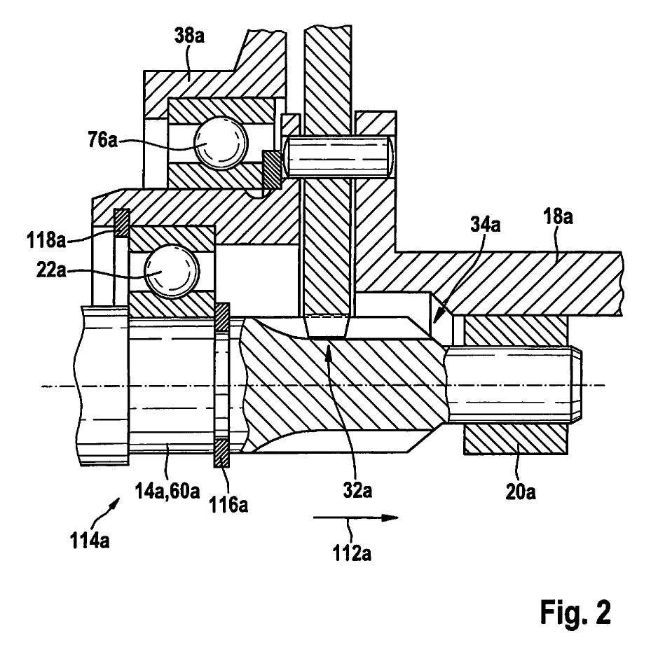

FIG. 2 shows a detail view of the mounting of driveshaft 14a. Driveshaft 14a is situated partially inside receptacle recess 34a of intermediate shaft 18a. Toothing 32a of driveshaft 14a with planetary wheels 26a, 28a, 30a takes place inside intermediate shaft 18b. Bearings 20a, 22a for mounting driveshaft 14a are situated on both sides of toothing 32a. A bearing 20a for mounting driveshaft 14a is situated behind toothing 32a along an insertion direction 112a of driveshaft 14a into receptacle recess 34a. Bearing 20a is designed as an antifriction bearing, in particular as a needle bearing. Bearing 20a may be pressed into receptacle recess 34a in particular. Second bearing 22a for mounting driveshaft 14a is situated in front of toothing 32a along insertion direction 112a of driveshaft 14a into receptacle recess 34a. Second bearing 22a is situated directly at an insertion opening 114a of receptacle recess 34a. Second bearing 22a is designed as an antifriction bearing, in particular as a ball bearing. Second bearing 22a is installed with the aid of a sliding fit and is secured in its position with the aid of two securing elements 116a, 118a, in particular with the aid of snap rings.

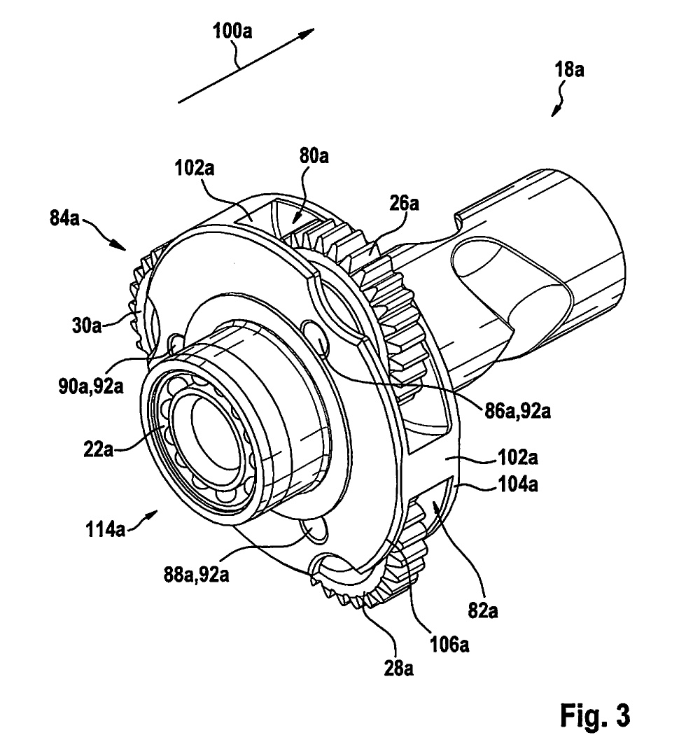

FIG. 3 shows intermediate shaft 18a in a perspective view. Intermediate shaft 18a has a plurality of planetary wheel receptacles 80a, 82a, 84a and planetary wheel bearing points 86a, 88a, 90a situated in the circumferential direction. A planetary wheel 26a, 28a, 30a, which is rotatably mounted with the aid of a pin 92a, is situated in each planetary wheel receptacle 80a, 82a, 84a. Planetary wheel bearing points 86a, 88a, 90a are each situated offset by at least essentially 120° in relation to one another in the circumferential direction on intermediate shaft 18a. Planetary wheel receptacles 80a, 82a, 84a are separated from one another by webs 102a extending radially in relation to a longitudinal extension direction 100a of intermediate shaft 18a. Viewed along longitudinal extension direction 100a of intermediate shaft 18a, planetary wheel receptacles 80a, 82a, 84a are delimited by two disk-shaped wall elements 104a, 106a, which are situated at least essentially perpendicularly in relation to longitudinal extension direction 100a. Wall elements 104a, 106a are formed at least essentially circularly. Wall elements 104a, 106a are formed in one piece with intermediate shaft 18a. Second bearing 22a is situated directly at an insertion opening 114a of receptacle recess 34a.

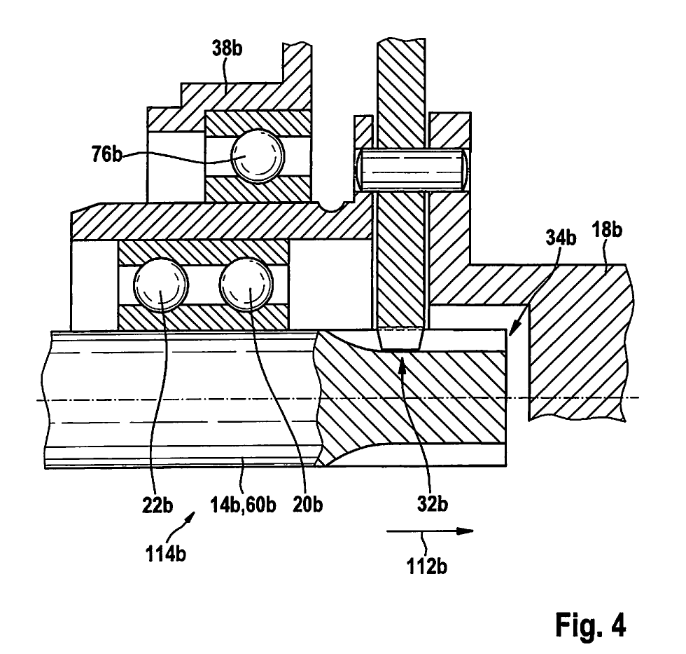

Two further exemplary embodiments of the present invention are shown in FIGS. 4 through 6. The following descriptions and the drawings are essentially restricted to the differences between the exemplary embodiments, reference also fundamentally being able to be made to the figures and/or the description of the other exemplary embodiments, in particular of FIGS. 1 through 3, with respect to identically labeled components, in particular with respect to components having identical reference numerals. To differentiate the exemplary embodiments, letter a is appended to the reference numerals of the exemplary embodiments in FIGS. 1 through 3. Letter a is replaced by letters b and c in the exemplary embodiments of FIGS. 4 through 6.

FIG. 4 shows a detail view of an alternative mounting of a driveshaft 14b. Driveshaft 14b is partially situated inside a receptacle recess 34b of an intermediate shaft 18b. A toothing 32b of driveshaft 14b with planetary wheels 26b, 28b, 30b of a planetary gear 24b takes place inside intermediate shaft 18b. Bearings 20a, 22a for mounting driveshaft 14a are both situated in front of toothing 32b along an insertion direction 112b of driveshaft 14b into a receptacle recess 34b of intermediate shaft 18b. Bearings 20b, 22b are situated at an insertion opening 114b of receptacle recess 34b. Bearings 20b, 22b are designed as antifriction bearings, in particular as ball bearings. Bearings 20b, 22b may be pressed into receptacle recess 34b in particular. Alternatively or additionally, bearings 20b, 22b may be secured in their position with the aid of at least one securing element, in particular with the aid of a snap ring, inside receptacle recess 34b. Bearings 20b, 22b are combined here, for example, to form a two-row antifriction bearing, in particular a two-row ball bearing. Alternatively, bearings 20b, 22b, may be designed as separate, in particular one-row antifriction bearings, in particular ball bearings.

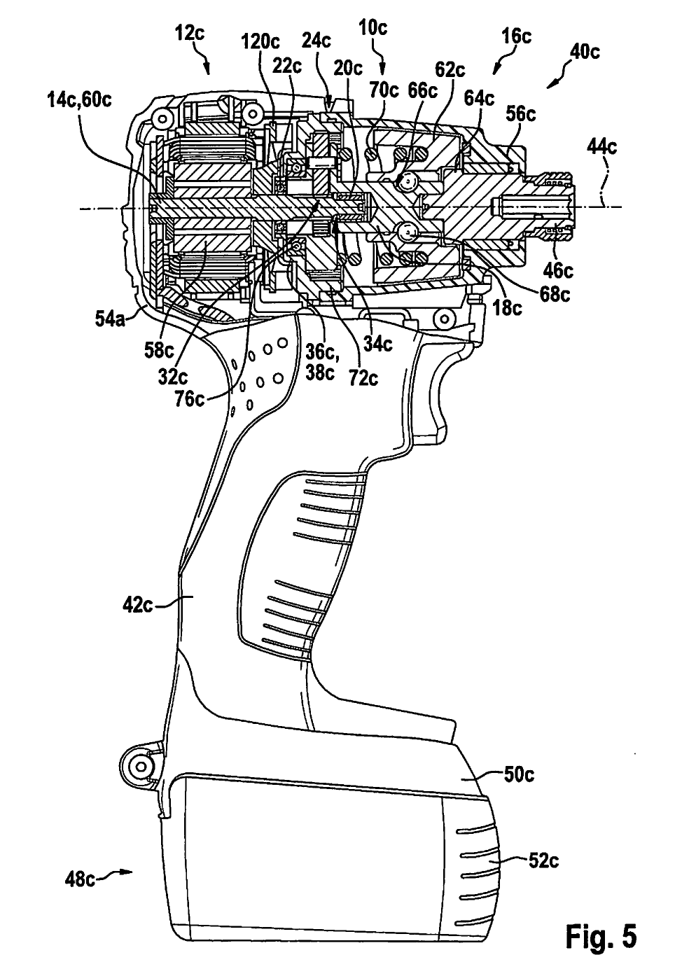

FIG. 5 shows an alternative handheld power tool 40c, which is designed as a rotary impact screwdriver, in a schematic partial sectional view. Hand-held power tool 40c is designed as a cordless rotary impact screwdriver. Hand-held power tool 40c includes a handle 42c, which extends at least essentially perpendicularly in relation to a rotation axis 44c of a tool holder 46c, which is provided for holding an insert tool (not shown here), of handheld power tool 40c. Handle 42c includes a rechargeable battery holder 50c on a side 48c facing away from handheld power tool 40c. Rechargeable battery holder 50c is provided for holding a rechargeable battery unit 52c for the power supply of handheld power tool 40c.

Furthermore, handheld power tool 40c includes a handheld power tool device 10c having a drive unit 12c and a rotary percussion mechanism 16c. Drive unit 12c is designed as an electrical drive unit, which is supplied with electrical energy with the aid of rechargeable battery unit 52c. Drive unit 12c is designed as an electric motor 58c, which is provided to convert the electrical energy provided by rechargeable battery unit 52c into rotational energy. Drive unit 12c has a driveshaft 14c, which is provided to transmit the rotational energy to rotary percussion mechanism 16c. Driveshaft 14c is formed by an armature shaft 60c of electric motor 58c. Armature shaft 60c is formed in one piece. Rotary percussion mechanism 16b is designed as a V-groove rotary percussion mechanism. Rotary percussion mechanism 16c is provided for converting a continuous power output of drive unit 12c into a percussion angular momentum.

Rotary percussion mechanism 16c has an intermediate shaft 18c, which is oriented at least essentially flush with respect to driveshaft 14c. Furthermore, handheld power tool device 10c has two bearings 20c, 22c for mounting driveshaft 14c. Bearings 20c, 22c for mounting driveshaft 14c are situated on a side of drive unit 12c facing away from rotary percussion mechanism 16c. Bearings 20c, 22c for mounting driveshaft 14c are situated inside rotary percussion mechanism 16c. Driveshaft 14c is mounted at least partially inside intermediate shaft 18c. Intermediate shaft 18c has a receptacle recess 34c, which is provided for at least partially accommodating driveshaft 14c. Receptacle recess 34c extends at least essentially along a rotation axis 44c of intermediate shaft 18c. Driveshaft 14c protrudes in an installed state at least partially into intermediate shaft 18c, in particular into receptacle recess 34c of intermediate shaft 18c. Bearings 20c, 22c for mounting driveshaft 14c are designed as antifriction bearings. A bearing 20c for mounting driveshaft 14c is situated inside intermediate shaft 18b. Second bearing 22c for mounting driveshaft 14c is situated inside an element 36c, which is different from intermediate shaft 18c, of rotary percussion mechanism 16c.

Rotary percussion mechanism 16c has at least one single-stage planetary gear 24c having a plurality of planetary wheels 26c, 28c, 30c interlocked with driveshaft 14c. Toothing 32c of driveshaft 14c with planetary wheels 26c, 28c, 30c is situated between bearings 20c, 22c for mounting driveshaft 14c. Planetary gear 24c includes at least one annulus gear 72c. Furthermore, rotary percussion mechanism 16c includes a percussion mechanism cover 38c. Percussion mechanism cover 38c is situated between drive unit 12c and planetary gear 24c. Percussion mechanism cover 38c is provided in particular for at least largely closing rotary percussion mechanism 16c in the direction of drive unit 12c. Percussion mechanism cover 38c is formed in one piece with annulus gear 72c. Percussion mechanism cover 38c and annulus gear 72c are at least essentially made of a metallic material, in particular a metallic sintered material. Second bearing 22c for mounting driveshaft 14c is situated inside percussion mechanism cover 38c.

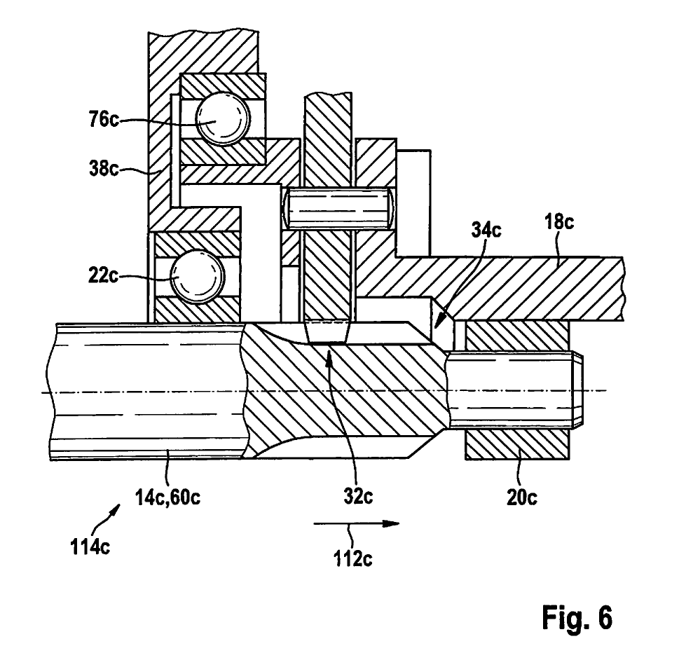

FIG. 6 shows a detail view of the mounting of driveshaft 14c. Driveshaft 14c is situated partially inside receptacle recess 34c of intermediate shaft 18a. Toothing 32c of driveshaft 14c with planetary wheels 26c, 28c, 30c takes place inside intermediate shaft 18c. Bearings 20c, 22c for mounting driveshaft 14c are situated on both sides of toothing 32c. A bearing 20c for mounting driveshaft 14c is situated behind toothing 32c along an insertion direction 112c of driveshaft 14c into receptacle recess 34c. Bearing 20c is designed as an antifriction bearing, in particular as a needle bearing. Bearing 20c may be pressed into receptacle recess 34c in particular. Second bearing 22c for mounting driveshaft 14c is situated in front of toothing 32c along insertion direction 112c of driveshaft 14c into receptacle recess 34c. Second bearing 22c is situated in percussion mechanism cover 38c. Second bearing 22c is designed as an antifriction bearing, in particular as a ball bearing. Second bearing 22c is installed with the aid of a press fit. Alternatively, second bearing 22c may be secured in its position in percussion mechanism cover 38c with the aid of at least one securing element, in particular with the aid of a snap ring.

What is claimed is:

1. A handheld power tool device, comprising:
a drive unit including at least one driveshaft;
at least one rotary percussion mechanism, which includes at least one intermediate shaft oriented at least essentially flush with respect to the driveshaft; and
at least two bearings for mounting the driveshaft, wherein the bearings for mounting the driveshaft are situated on a side of the drive unit facing toward the rotary percussion mechanism.

2. The handheld power tool device as recited in claim 1, wherein the bearings for mounting the driveshaft are situated inside the rotary percussion mechanism.

3. The handheld power tool device as recited in claim 1, wherein the rotary percussion mechanism includes at least one planetary gear having a plurality of planetary wheels interlocked with the driveshaft, toothing of the driveshaft with the planetary wheels being situated between the bearings for mounting the driveshaft.

4. The handheld power tool device as recited in claim 1, wherein the driveshaft is mounted at least partially inside the intermediate shaft.

5. The handheld power tool device as recited in claim 1, wherein the intermediate shaft includes at least one receptacle recess, which is provided for at least partially accommodating the driveshaft.

6. The handheld power tool device as recited in claim 1, wherein at least one of the bearings for mounting the driveshaft is situated inside the intermediate shaft.

7. The handheld power tool device as recited in claim 1, wherein at least one bearing for mounting the driveshaft is situated inside at least one element of the rotary percussion mechanism different from an intermediate shaft.

8. The handheld power tool device as recited in claim 1, wherein the rotary percussion mechanism includes at least one percussion mechanism cover and at least one bearing for mounting the driveshaft is situated inside the percussion mechanism cover.

9. The handheld power tool device as recited in claim 1, wherein all bearings for mounting the driveshaft are situated inside the intermediate shaft.

10. A handheld power tool including at least one handheld power tool device, the handheld power tool device comprising:
a drive unit including at least one driveshaft;
at least one rotary percussion mechanism, which includes at least one intermediate shaft oriented at least essentially flush with respect to the driveshaft; and
at least two bearings for mounting the driveshaft, wherein the bearings for mounting the driveshaft are situated on a side of the drive unit facing toward the rotary percussion mechanism.
